(19) United States
(12) Patent Application Publication
(10) Pub. No.: US 2026/0217395 A1
(43) Pub. Date: Jul. 30, 2026

(54) CHARGING AN UNMANNED AERIAL VEHICLE USING RAIL ELECTRIFIED AT GROUND LEVEL

(71) Applicant: Microchip Technology Inc., Chandler, AZ (US)

(72) Inventors: Valentin Stoia, Bucharest (RO); Mihaela Dumitru, Bucharest (RO)

(73) Assignee: Microchip Technology Inc., Chandler, AZ (US)

(21) Appl. No.: 19/186,962

(22) Filed: Apr. 23, 2025

Related U.S. Application Data
(60) Provisional application No. 63/751,691, filed on Jan. 30, 2025.

(51) Int. Cl. B64U 50/38; B64U 70/93; G05D 1/689; G08G 5/20; G05D 109/25

(52) U.S. Cl. CPC B64U 50/38; B64U 70/93; G05D 1/689; G08G 5/20; B64U 2201/20; G05D 2109/254

(57) ABSTRACT

A system, apparatus, and method for charging an unmanned aerial vehicle using rail electrified at ground-level are disclosed. The apparatus may include a power management circuit interface. The apparatus may also include a navigation circuit interface. The apparatus may further include a control circuit. The control circuit may be to navigate an unmanned aerial vehicle (UAV) to a rail based on information received via the navigation circuit interface. The rail may be configured to be electrified at ground-level. The control circuit may also be to instruct the UAV to couple a charging contact on the UAV with a charging contact coupled to the rail. The control circuit may additionally be to coordinate a charging operation between the UAV and the rail via the power management circuit interface. The control circuit may further be to instruct the UAV to disengage the charging contact on completion of the charging operation.

### PRIORITY

This application claims priority to U.S. Provisional Patent Application No. 63/751,691 filed January 30, 2025, the contents of which are hereby incorporated in their entirety.

### TECHNICAL FIELD

The present disclosure relates to powering unmanned aerial vehicles, and, in particular, to charging an unmanned aerial vehicle using rail electrified at ground-level.

### BACKGROUND

Delivery drones are unmanned aerial vehicles (UAVs) designed to transport goods such as packages, food, and medicine. They may offer a faster, more efficient, and environmentally friendly alternative to traditional delivery methods. While there are still regulatory and logistical challenges to overcome, the potential benefits of delivery drones are significant, and they are likely to play a major role in the future of transportation.

Delivery drones face several range limitations that hinder their widespread adoption. For example, drones rely on batteries, and current battery technology limits flight times. Most delivery drones can fly for approximately 20 to 30 minutes on a single charge, restricting their range to a few miles. Additionally, the weight of the package affects the drone's flight time and range. Heavier payloads use more power, reducing the distance a drone can travel. Further, as the number of drones in the sky increases, air traffic control systems will manage their flight paths to avoid collisions, which may lead to limitations on range and routes.

### SUMMARY OF THE INVENTION

Aspects provide systems and methods for charging an unmanned aerial vehicle using rail electrified at ground-level. Examples of the present disclosure may include an apparatus. The apparatus may include a power management circuit interface. The apparatus may also include a navigation circuit interface. The apparatus may further include a control circuit. The control circuit may be to navigate an unmanned aerial vehicle (UAV) to a rail based on information received via the navigation circuit interface. The rail may be configured to be electrified at ground-level. The control circuit may also be to instruct the UAV to couple a charging contact on the UAV with a charging contact coupled to the rail. The control circuit may additionally be to coordinate a charging operation between the UAV and the rail via the power management circuit interface. The control circuit may further be to instruct the UAV to disengage the charging contact on completion of the charging operation.

In combination with any of the above examples, the control circuit may be to instruct the UAV to land on a mobile platform coupled to the rail.

In combination with any of the above examples, the control circuit may be to receive a beacon signal from the mobile platform. The control circuit may also be to align the UAV with the mobile platform based on the beacon signal.

In combination with any of the above examples, the control circuit may be to engage a presence detection circuit to enable the rail.

In combination with any of the above examples, the control circuit may be to instruct a power management circuit to convert a direct current at a first voltage to a second voltage.

In combination with any of the above examples, the control circuit may be to broadcast a location of the UAV.

In combination with any of the above examples, the control circuit may be to extend the charging contact from the UAV.

Alone or in combination with any of the above examples, examples of the present disclosure may include a method. The method may include navigating an unmanned aerial vehicle (UAV) to a rail configured to be electrified at ground-level. The method may also include coupling a charging contact on the UAV with a charging contact coupled to the rail. The method may additionally include coordinating a charging operation between the UAV and the rail. The method may further include instructing the UAV to disengage the charging contact on completion of the charging operation.

In combination with any of the above examples, the method may include instructing the UAV to land on a mobile platform coupled to the rail.

In combination with any of the above examples, the method may include receiving a beacon signal from the mobile platform. The method may also include aligning the UAV with the mobile platform based on the beacon signal.

In combination with any of the above examples, the method may include engaging a presence detection circuit to enable the rail.

In combination with any of the above examples, the method may include converting a direct current at a first voltage to a second voltage.

In combination with any of the above examples, the method may include broadcasting a location of the UAV.

In combination with any of the above examples, the method may include extending the charging contact from the UAV.

Alone or in combination with any of the above examples, examples of the present disclosure may include a system. The system may include a mobile platform to operate on and receive power from a rail. The rail may be configured to be electrified at ground-level. The system may also include a first charging contact coupled to the mobile platform. The system may further include a control circuit. The control circuit may be to enable a navigation aid to assist an unmanned aerial vehicle (UAV) in navigating to the mobile platform. The control circuit may also be to coordinate a charging operation between the UAV and the rail via the first charging contact coupled to a second charging contact on the UAV.

In combination with any of the above examples, the control circuit may be to instruct the UAV to disengage with the first charging contact.

In combination with any of the above examples, the control circuit may be to broadcast a beacon signal for use by the UAV in aligning with the mobile platform.

In combination with any of the above examples, the control circuit may be to engage a presence detection circuit of the rail to enable the rail.

In combination with any of the above examples, the control circuit may be to convert a direct current at a first voltage to a second voltage.

In combination with any of the above examples, the control circuit may be to broadcast a location of the mobile platform.

### BRIEF DESCRIPTION OF THE DRAWINGS

The figures illustrate examples of systems and methods for charging an unmanned aerial vehicle using rail electrified at ground-level.

FIG. 1 illustrates a rail-based ground-level power supply sharing service for unmanned aerial vehicles (UAVs), according to examples of the present disclosure;

FIG. 2 illustrates a rail-based ground-level power supply sharing service for UAVs, according to examples of the present disclosure;

FIGS. 3A and 3B illustrate a perspective view and top view, respectively, of a mobile platform based rail-based ground-level power supply sharing service for UAVs;

FIG. 4 illustrates a railway used for a rail-based ground-level power supply sharing service for UAVs, according to examples of the present disclosure;

FIG. 5 illustrates a block diagram of a UAV used for a rail-based ground-level power supply sharing service for UAVs, according to examples of the present disclosure;

FIG. 6 illustrates a block diagram of a mobile platform used for a rail-based ground-level power supply sharing service for UAVs, according to examples of the present disclosure;

FIG. 7 illustrates a block diagram of a railway used for a rail-based ground-level power supply sharing service for UAVs, according to examples of the present disclosure; and

FIG. 8 illustrates a method for charging an unmanned aerial vehicle using rail electrified at ground-level, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, systems and methods for charging an unmanned aerial vehicle using rail electrified at ground-level are provided. The charging service may use existing rail-based power supplies (e.g., rails electrified at ground-level used for trains and trams) for recharging unmanned aerial vehicles. Specifically, the existing rails may be used to transport the unmanned aerial vehicle for a portion of its route, increasing the range of the unmanned aerial vehicle and decongesting airspace. The unmanned aerial vehicle may use less energy by leveraging energy available from the existing rail and may be able to be used more frequently by allowing the unmanned aerial vehicle to charge during a portion of the route of the unmanned aerial vehicle. Additionally, in some examples, the unmanned aerial vehicle may travel through congested or dangerous areas on the railway to avoid or reduce human exposure to potential danger created by the use of unmanned aerial vehicles.

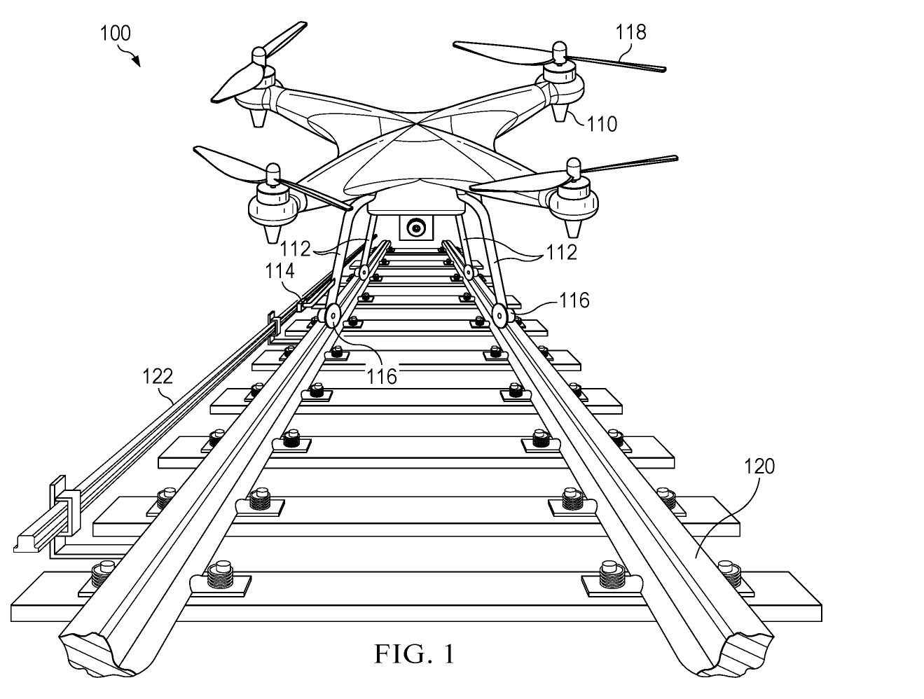

FIG. 1 illustrates a rail-based ground-level power supply sharing service for unmanned aerial vehicles (UAVs), according to examples of the present disclosure. System 100 may include UAV 110 and railway 120. UAV 110 may be an unmanned aerial vehicle used to deliver packages, for military applications, inspections, photography, or any suitable use. Railway 120 may be existing rail electrified at ground-level and used for private or public uses (e.g., trains, trams, metros, above ground subways). Railway 120 may be located on the ground or may be elevated above the ground.

In some examples, UAV 110 may have a size sufficiently large such that legs 112 of UAV 110 may span the two tracks of railway 120. Railway 120 may be electrified such that UAV 110 may draw power from railway 120. For example, UAV 110 may include connector 114 (sometimes referred to as a “collector shoe”) that slides along rail 122 to collect power from rail 122. In some examples UAV 110 may include one or more supercapacitors for fast recharging. The supercapacitors may be configured to rapidly store large amounts of electrical energy from the railway 120, potentially allowing for shorter charging times compared to traditional battery systems.

UAV 110 may navigate through the air to railway 120 to intercept railway 120, land on railway 120, and travel along railway 120 for a portion of the route from the starting point of UAV 110 to the destination of UAV 110. When UAV 110 nears its destination, UAV 110 may take off from railway 120 and proceed to its destination through the air. While UAV 110 travels along railway 120, UAV 110 may charge batteries onboard UAV 110.

UAV 110 may have legs 112 to allow UAV 110 to land on railway 120. In some examples, legs 112 may be extendable. The legs may include wheels 116 such that UAV 110 may land on the tracks and travel on the tracks of railway 120 like a rail car travels on the tracks of railway 120. In some examples, wheels 116 may be electrically conductive to support UAV 110 while allowing UAV 110 to move on the rails while receiving power via the electrically conductive rails.

While travelling on railway 120, UAV 110 may propel itself using any suitable propulsion mechanism, such as an electric motor that drives wheels 116 or one or more propellers 118 that pull or push UAV 110 along railway 120. Propellers 118 may be the same propellers that propel UAV 110 during flight and may rotate to provide forward propulsion.

UAV 110 may include a high-to-low direct current (DC) voltage converter to allow UAV 110 to receive power and charge from railway 120. For example, the high-to-low DC voltage converter may convert the high power from railway 120 (e.g., 750 volts (V)) to a lower power that is compatible with the power system of UAV 110 (e.g., 48 V).

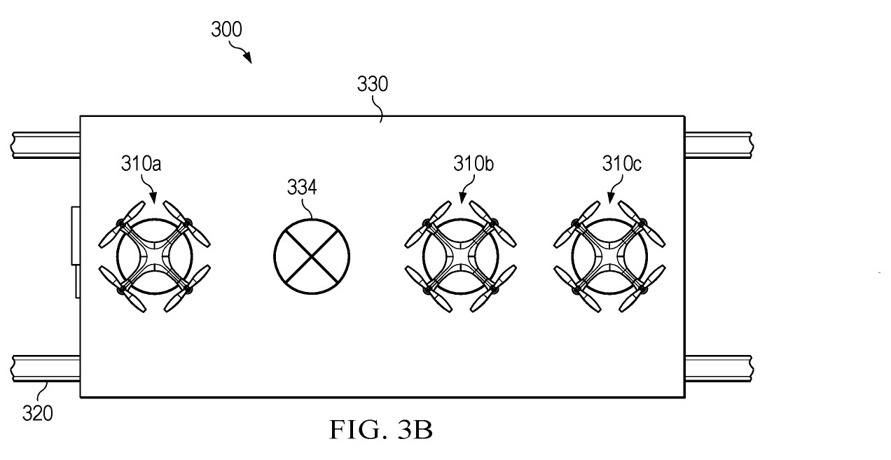

UAV 110 may include precision landing aids to assist UAV 110 in landing on railway 120. For example, UAV 110 may use global positioning service (GPS) or global system for mobile communications (GSM) information, image recognition, metal detection of the rails of railway 120, patterns painted near railway 120, or any combination thereof. Navigational aids installed near railway 120 are described in more detail with reference to FIG. 4.

Railway 120 may be equipped with a presence detection system such that a portion of railway 120 is electrified when the default vehicle (e.g., train, tram, railcar) using railway 120 is present in the proximity of the portion of railway 120 and not electrified with the default vehicle is not present. For example, the portions of railway 120 under the default vehicle may be electrified while other portions of railway 120 are not electrified. UAV 110 may also include radio frequency (RF) or RF identification (RFID) functionality to mimic the presence of a default vehicle such that the portion of railway 120 proximate to UAV 110 is electrified. UAV 110 may also include security functionality to allow it to interface with railway 120.

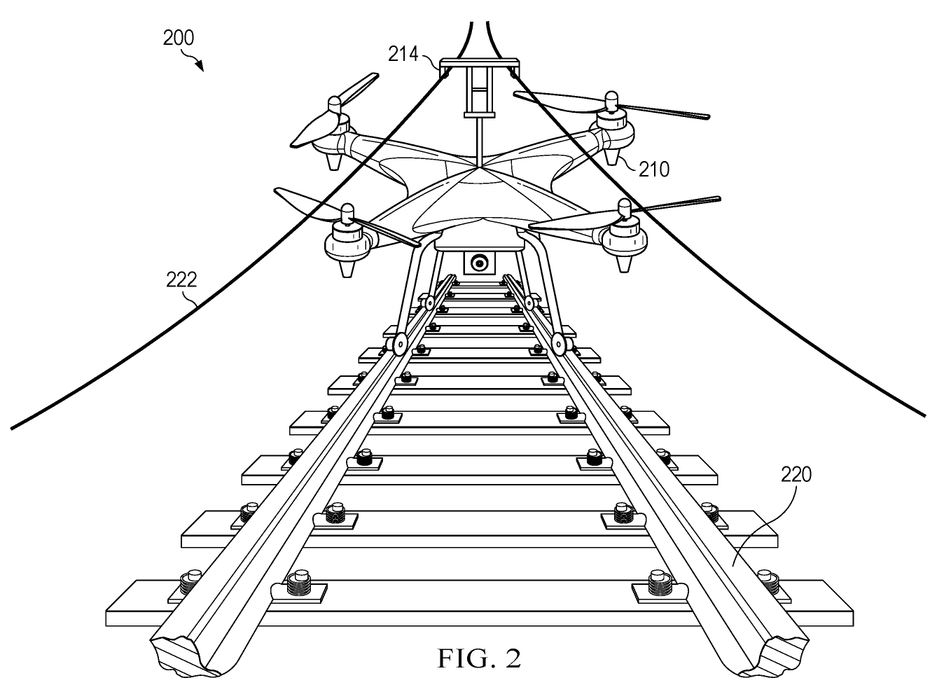

FIG. 2 illustrates a rail-based ground-level power supply sharing service for UAVs, according to examples of the present disclosure. System 200 may include UAV 210 and railway 220. UAV 210 may be similar to UAV 110 shown in FIG. 1 and railway 220 may be similar to railway 120 shown in FIG. 1.

Instead or, or in addition to, connector 114 shown in FIG. 1, UAV 210 may include pantograph 214 to couple to overheads lines 222 suspended above the tracks of railway 220. UAV 210 may draw power from overhead lines 222 via pantograph 214 and charge batteries on UAV 210 from overhead lines 222.

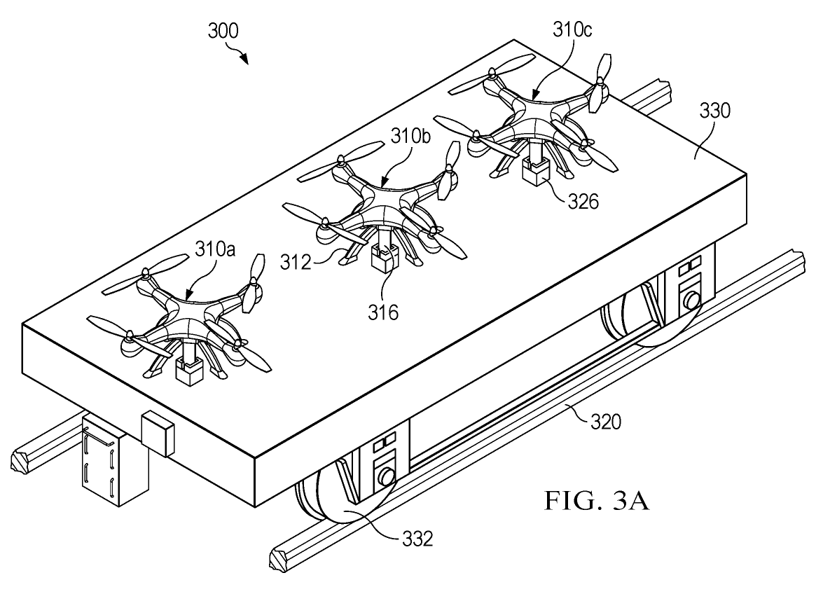

FIGS. 3A and 3B illustrate a perspective view and top view, respectively, of a mobile platform based rail-based ground-level power supply sharing service for UAVs, according to examples of the present disclosure, according to examples of the present disclosure. System 300 may include UAV 310, railway 320, and platform 330. Railway 320 may be similar to railway 120 or railway 220 shown in FIGS. 1 and 2, respectively.

UAV 310 may have a smaller size than UAV 110 or UAV 210 shown in FIGS. 1 and 2, respectively, such that UAV 310 is too small to span the two tracks of railway 320. Platform 330 may be designed to travel on railway 320 to allow UAV 310 to travel along railway 320 while docked on platform 330. Platform 330 may draw power from railway 320 and provide power to UAV 310 to allow UAV 310 to recharge while UAV 310 is docked on platform 330. For example, platform 330 may include a connector similar to connector 114 shown in FIG. 1 to couple with a third rail of railway 320 or a pantograph similar to pantograph 214 shown in FIG. 2 to couple with overhead lines proximate to railway 320. Platform 330 may receive power via the connector or the pantograph from the third rail or the overhead lines.

Platform 330 may include wheels 332 such that platform 330 travels on the tracks of railway 320. In some examples, wheels 332 may be electrically conductive to allow platform 330 to receive power via the electrically conductive rails of railway 320. While travelling on railway 320, platform 330 may propel itself using any suitable propulsion mechanism, such as one or more electric motors that drives wheels 332. The electric motors may be powered from railway 320. Alternatively, or in addition to, platform 330 may be powered by a gasoline or diesel engine onboards platform 330.

UAV 310 may navigate through the air to railway 320 to intercept railway 320, land on platform 330, and travel along railway 320 for a portion of the route from the starting point of UAV 210 to the destination of UAV 210 while docked to platform 330. When UAV 310 nears its destination, UAV 310 may take off from platform 330 and proceed to its destination via air. While UAV 310 is traveling atop platform 330, UAV 310 may charge the batteries onboard UAV 310. UAV 310 may have legs 312 to allow it to land on railway 320. In some examples, legs 312 may be extendable.

Platform 330 may include a high-to-low DC voltage converter to allow UAV 310 to be recharged from railway 320. For example, the high-to-low DC voltage converter may convert the high power from railway 320 (e.g., 750 V) to a lower power that is compatible with the recharging system of UAV 310 (e.g., 48 V).

Platform 330 may also include RF or RFID functionality to mimic the presence of a default vehicle such that the portion of railway 320 proximate to platform 330 is electrified. Platform 330 may also include security functionality to allow it to interface with railway 320.

Platform 330 may be autonomous. In some examples, platform 330 may operate according to a predetermined schedule such that an operator of UAV 310 may plan a route for UAV 310 based on the schedule platform 330. In some examples, platform 330 may include GPS or GSM capabilities such that the location of platform 330 may be provided to the operator of UAV 310 (e.g., via an online portal, mobile application). This may allow the operator of UAV 310 to coordinate the route of UAV 310 with the location and availability of platform 330. Additionally, UAV 310 may broadcast its location to allow the operator of UAV 310 to track the location of UAV 310.

Platform 330 may contain space for multiple UAVs 310a, 310b, and 310c such that multiple UAVs 310a, 310b, and 310c may travel on platform 330 at the same time. In some examples, the operator of UAV 310 may reserve space on platform 330 in advance. The operator of UAV 310 may access information about the route of platform 330 and the availability of space on platform 330 when planning the route of UAV 310. The operator may determine where UAV 310 may intercept platform 330 and where UAV 310 may depart platform 330 to result in a route for UAV 310 that uses the battery power available to UAV 310 efficiently.

Platform 330 may contain a docking station to allow UAV 310 to interface with platform 330. The docking station may include a mechanical mechanism to lock UAV 310 into a safe position while on platform 330. After docking, UAV 310 may be charged using contact-based or wireless charging. For example, the docking station may have charging contact 326 to interface with charging contact 316 on UAV 310 to allow UAV 310 to be recharged while docked to platform 330. Charging contact 316 may be a probe that extends from UAV 310 to engage with charging contact 326. In some examples, UAV 310 may include one or more supercapacitors for fast recharging. The supercapacitors may be configured to rapidly store large amounts of electrical energy from the railway 320, potentially allowing for shorter charging times compared to traditional battery systems. When the charging operation is complete, platform 330 may instruct UAV to disengage charging contact 316 from charging contact 326.

Platform 330 may include navigational systems to aid UAV 310 in landing on platform 330 and docking with platform 330. The navigational system include, but are not limited to, image-based localization, infrared, or RF triangulation. For example, platform 330 may include visual target 334 to provide a visual cue to UAV 310 to allow UAV 310 to land at a docking station on platform 330. UAV 310 may also include precision landing aids to assist UAV 310 in landing on platform 330. For example, UAV 310 may use GPS information, image recognition, RF triangulation, infrared sensing, patterns painted on platform 330, or any combination thereof. Navigational aids that may be installed near railway 320 are described in more detail with reference to FIG. 4.

FIG. 4 illustrates a railway used for a rail-based ground-level power supply sharing service for UAVs, according to examples of the present disclosure. System 400 may include railway 420 and navigational aid 440. Railway 420 may be similar to railway 420, railway 220, or railway 320 shown in FIGS. 1, 2, and 3, respectively.

Railway 420 may be modified to enable the power supply sharing service. For example, railway 420 may allow in-rail electric power activation for vehicles, such as UAV 110 or platform 330, because UAV 110 and platform 330 may be shorter than the default vehicle using railway 420.

Railway 420 may also include one or more navigational aids 440 to assist the UAV in landing on railway 420 or on platform 330 operating on railway 420. Navigational aid 440 may be a GPS signal, visual (e.g., painted) alignment lines (or quick-response (QR) code), lights (including infrared lights), RF beacon, or any other suitable navigational aid. For example, navigational aid 440 may be similar to navigational aids used near runways, such as visual approach slope indicator (VASI) lights, precision approach path indicators (PAPIs), or optical landing system (OLS) lights. In some examples, railway 420 may also include edge lights to provide for navigation and landing at night or in low-light conditions.

Railway 420 may be shared between the UAV and platforms operating on railway 420 and the default vehicles using railway 420. Traffic management and sharing prioritization may be handled by an online coordination center when all users of railway 420 are connected and continuously sharing current location data. Additional safety mechanisms may be implemented on the vehicles (including the UAV and platform) using railway 420, such as, but not limited to, light detection and ranging (LiDAR), radar, image recognition, or any combination thereof.

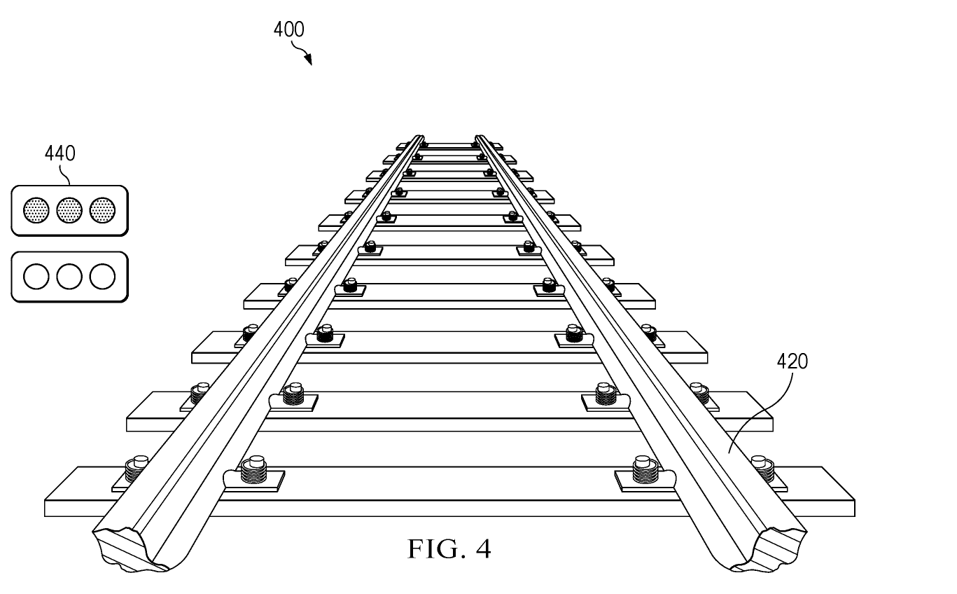

FIG. 5 illustrates a block diagram of a UAV used for a rail-based ground-level power supply sharing service for UAVs, according to examples of the present disclosure. UAV 500 may include control circuit 510, flight control circuit 520, navigation circuit 530, power management circuit 540, battery 542, contacts 544, and communication circuit 550. UAV 500 may be similar to UAV 110, UAV 210, or UAV 310 shown in FIGS. 1, 2, and 3, respectively.

Control circuit 510 may serve as the central control for UAV 500, coordinating the functions of various components and executing instructions for navigation and charging tasks. In some examples, control circuit 510 may be implemented by instructions for execution by a processor, analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. Control circuit 510 may be implemented by instructions for execution by a processor through, for example, a function, application programming interface (API) call, script, program, compiled code, interpreted code, binary, executable, executable file, firmware, object file, container, assembly code, or object. For example, control circuit 510 may be implemented by instructions stored in a non-transitory medium such as a memory that, when loaded and executed by a processor such as a central processing unit (CPU) (or any other suitable process), cause the functionality of control circuit 510 described herein.

Control circuit 510 may be communicatively coupled to flight control circuit 520 via a flight control circuit interface. Flight control circuit 520 may manage the flight operations of UAV 500, including, but not limited to, controlling motors, adjusting altitude, maintaining stability, and executing flight maneuvers. Flight control circuit 520 may receive commands from control circuit 510 and translate commands into specific motor control signals.

Control circuit 510 may be communicatively coupled to navigation circuit 530 via a navigation circuit interface. Navigation circuit 530 may determine the position of UAV 500, plan routes, and guide UAV 500 to its destination. Navigation circuit 530 may also guide UAV 500 to landing on a railway or a platform, such as railway 120 or platform 330, shown in FIGS. 1 and 3, respectively. Navigation circuit 530 may use any suitable positioning technologies, such as GPS, inertial measurement units (IMUs), or visual odometry systems. Navigation circuit 530 may work in conjunction with flight control circuit 520 to execute planned routes.

Control circuit 510 may also be communicatively coupled to power management circuit 540 via a power management circuit interface. Power management circuit 540 may manage the power systems of UAV 500, including monitoring battery levels, controlling charging processes, and optimizing power consumption. Power management circuit 540 may include, or be coupled to, battery 542 and contacts 544. Battery 542 may store energy for the operation of UAV 500. Contacts 544 may interface with external power sources, such as the railway or platform.

Control circuit 510 may be communicatively coupled to communication circuit 550 via a communication circuit interface. Communication circuit 550 may be configured to manage communication between UAV 500 and external systems, including, but not limited to, receiving commands from a ground control station, transmitting telemetry data, broadcasting location data, and coordinating with other UAVs or the rail system infrastructure. Communication circuit 550 may support any suitable wireless communication protocols.

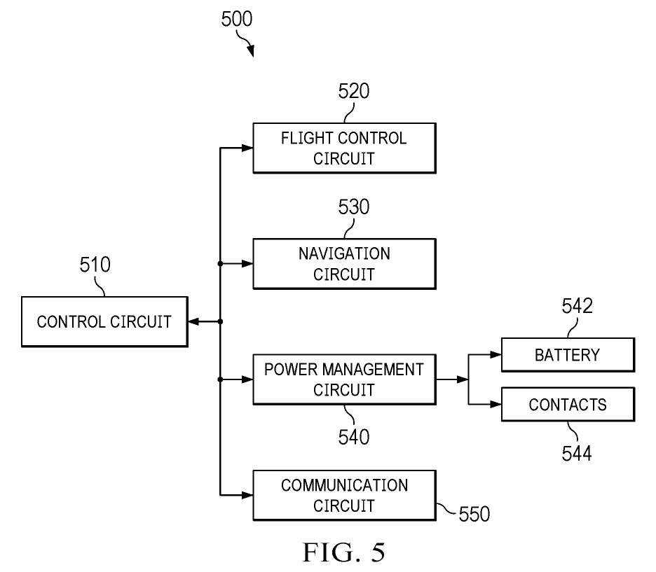

FIG. 6 illustrates a block diagram of a mobile platform used for a rail-based ground-level power supply sharing service for UAVs, according to examples of the present disclosure. Platform 600 may include platform control circuit 610, navigation aid 620, power distribution circuit 630, docking station 632, and communication circuit 640. Platform 600 may be similar to platform 330 shown in FIGS. 3A and 3B.

Platform control circuit 610 may serve as the central control for platform 600, coordinating the functions of various components and executing instructions for charging tasks. In some examples, platform control circuit 610 may be implemented by instructions for execution by a processor, analog circuitry, digital circuitry, control logic, digital logic circuits programmed through hardware description language, ASIC, FPGA, PLD, or any suitable combination thereof, whether in a unitary device or spread over several devices. Platform control circuit 610 may be implemented by instructions for execution by a processor through, for example, a function, API call, script, program, compiled code, interpreted code, binary, executable, executable file, firmware, object file, container, assembly code, or object. For example, platform control circuit 610 may be implemented by instructions stored in a non-transitory medium such as a memory that, when loaded and executed by a processor such as a CPU (or any other suitable process), cause the functionality of platform control circuit 610 described herein.

Platform control circuit 610 may be coupled to navigation aid 620. Navigation aid 620 may assist UAVs in locating, approaching, and aligning with platform 600. Navigation aid 620 may include any suitable combination of technologies, such as GPS beacons, visual markers, or radio frequency (RF) transmitters. These navigation aids may work in conjunction with the UAV’s onboard navigation systems to ensure precise positioning during landing and takeoff operations.

Platform control circuit 610 may be coupled to power distribution circuit 630. Power distribution circuit 630 may manage the flow of electrical power from the railway to the charging systems for UAVs. Power distribution circuit 630 may include any suitable components for voltage regulation, current control, and safety mechanisms to protect both the rail infrastructure and the UAVs during charging operations. Power distribution circuit 630 may be coupled to docking station 632. Docking station 632 may provide a physical interface between a UAV and platform 600. Docking station 632 may include any suitable number of charging ports or contact points that allow UAVs to connect to the power supply. When a charging operation is complete, platform control circuit 610 may instruct the UAV to disengage from power distribution circuit 630.

Platform control circuit 610 may also be coupled to communication circuit 640. Communication circuit 640 may manage data exchange between platform 600, a UAV, or components of the railway system. For example, communication circuit 640 may communicate with approaching UAVs, coordinate with traffic management systems, and relay status information to central control stations.

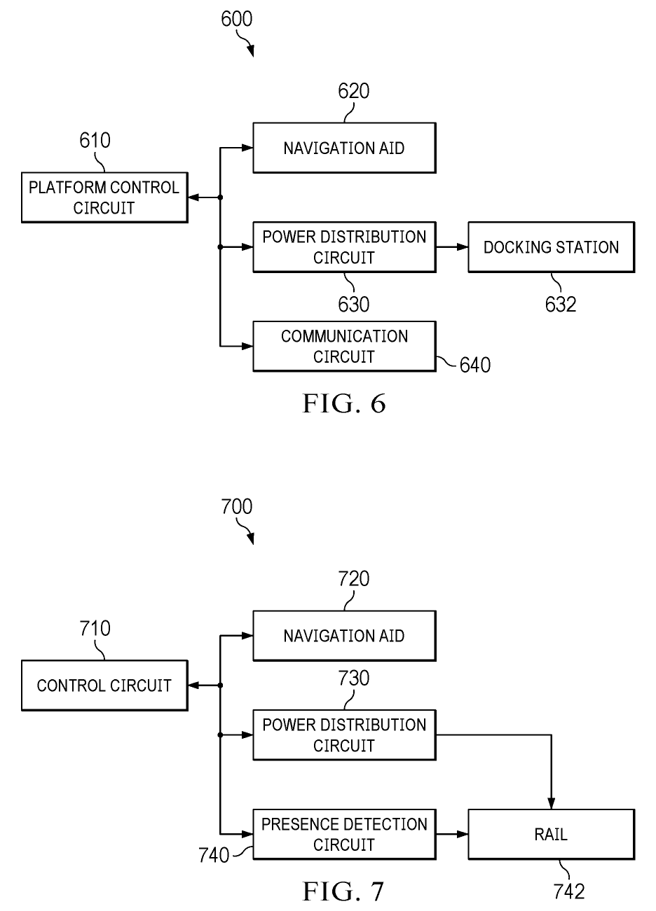

FIG. 7 illustrates a block diagram of a railway used for a rail-based ground-level power supply sharing service for UAVs, according to examples of the present disclosure. Railway 700 may include control circuit 710, navigation aid 720, power distribution circuit 730, presence detection circuit 740, and rail 742. Railway 700 may be similar to railway 120, railway 220, railway 320, or railway 420 shown in FIGS. 1, 2, 3, and 4,respectively.

Control circuit 710 may serve as the central control for railway 700, coordinating the functions of various components and executing instructions for charging tasks. In some examples, control circuit 710 may be implemented by instructions for execution by a processor, analog circuitry, digital circuitry, control logic, digital logic circuits programmed through hardware description language, ASIC, FPGA, PLD, or any suitable combination thereof, whether in a unitary device or spread over several devices. Control circuit 710 may be implemented by instructions for execution by a processor through, for example, a function, API call, script, program, compiled code, interpreted code, binary, executable, executable file, firmware, object file, container, assembly code, or object. For example, control circuit 710 may be implemented by instructions stored in a non-transitory medium such as a memory that, when loaded and executed by a processor such as a CPU (or any other suitable process), cause the functionality of control circuit 710 described herein.

Control circuit 710 may be coupled to navigation aid 720. Navigation aid 720 may assist UAVs in locating, approaching, and aligning with railway 700. Navigation aid 720 may include any suitable combination of technologies, such as GPS beacons, visual markers, or radio frequency (RF) transmitters. These navigation aids may work in conjunction with the UAV’s onboard navigation systems to ensure precise positioning during landing and takeoff operations. For example, navigation aid 720 may be similar to navigation aid 440 shown in FIG. 4.

Control circuit 710 may be coupled to power distribution circuit 730. Power distribution circuit 730 may be configured to manage the flow of electrical power from rail 742 to the charging systems for UAVs. Power distribution circuit 730 may include any suitable components for voltage regulation, current control, and safety mechanisms to protect both the rail infrastructure and the UAVs during charging operations.

Control circuit 710 may be coupled to presence detection circuit 740. Presence detection circuit 740 may detect the presence of UAVs, platforms, or other authorized vehicles on rail 742. Presence detection circuit 740 may use any suitable sensors or detection methods, such as weight sensors, optical sensors, or RFID systems, to identify when a UAV or platform is in position for charging and activate rail 742. Rail 742 may be electrified at ground-level and may be a source of power for the UAV charging system. Presence detection circuit 740 may ensure that power is supplied to sections of rail 742 where UAVs are present and not supplied to other sections of rail 742.

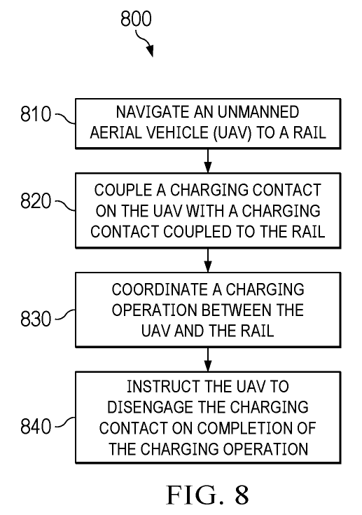

FIG. 8 illustrates a method for charging an unmanned aerial vehicle using rail electrified at ground-level, according to examples of the present disclosure. Method 800 may be implemented by a control circuit on a UAV, such as control circuit 510 shown in FIG. 5. Although examples have been described above, other variations and examples may be made from this disclosure without departing from the spirit and scope of these disclosed examples.

Method 800 may begin at block 810, where a UAV may be navigated to a rail. The UAV may navigate through the air to the rail to intercept the rail, land on the rail, and travel along the rail for a portion of the route from the starting point of the UAV to the destination of the UAV. The UAV may be navigated using any suitable positioning technologies, such as GPS, inertial measurement units (IMUs), or visual odometry systems. The UAV may be instructed to land on a platform operating on the rail. In some examples, the UAV may receive a beacon signal from the mobile platform. In response, the UAV may align itself with the mobile platform based on the beacon signal.

At block 820, the UAV may be coupled to a charging contact coupled to the rail. The charging contact may be a collector shoe, a pantograph, or a probe. In some examples, the UAV may be coupled to the rail via a platform, such as platform 330 shown in FIGS. 3A and 3B. In some examples, the UAV may extend a charging contact (e.g., a probe) to couple to the rail or platform.

At block 830, a charging operation between the UAV and the rail may be coordinated. The charging operation may be coordinated by a control circuit in conjunction with a power management circuit, such as power management circuit 540 shown in FIG. 5, to charge one or more batteries on the UAV. The charging operation may include converting a direct current from a first voltage to a second voltage. For example, the high-to-low DC voltage converter may convert the high power from railway 120 (e.g., 750 V) to a lower power that is compatible with the power system of UAV 110 (e.g., 48 V). In some examples, a presence detection circuit may be engaged to enable the rail.

At block 840, the UAV may be instructed to disengage the charging contact on completion of the charging operation. When charging is complete, the UAV may take off from the rail or a platform operating on the rail to continue to its destination.

Although FIG. 8 discloses a particular number of operations related to method 800, method 800 may be executed with greater or fewer operations than those depicted in FIG. 8. In addition, although FIG. 8 discloses a certain order of operations to be taken with respect to method 800, the operations comprising method 800 may be completed in any suitable order.

Although examples have been described above, other variations and examples may be made from this disclosure without departing from the spirit and scope of these disclosed examples.

What is claimed is:

1. An apparatus, comprising:
a power management circuit interface;
a navigation circuit interface; and
a control circuit to:
navigate an unmanned aerial vehicle (UAV) to a rail based on information received via the navigation circuit interface, the rail configured to be electrified at ground-level;
instruct the UAV to couple a charging contact on the UAV with a charging contact coupled to the rail;
coordinate a charging operation between the UAV and the rail via the power management circuit interface; and
instruct the UAV to disengage the charging contact on completion of the charging operation.

2. The apparatus of claim 1, wherein the control circuit is to instruct the UAV to land on a mobile platform coupled to the rail.

3. The apparatus of claim 2, wherein the control circuit is to:
receive a beacon signal from the mobile platform; and
align the UAV with the mobile platform based on the beacon signal.

4. The apparatus of claim 1, wherein the control circuit is to engage a presence detection circuit to enable the rail.

5. The apparatus of claim 1, wherein the control circuit is to instruct a power management circuit to convert a direct current at a first voltage to a second voltage.

6. The apparatus of claim 1, wherein the control circuit is to broadcast a location of the UAV.

7. The apparatus of claim 1, wherein the control circuit is to extend the charging contact from the UAV.

8. A method, comprising:
navigating an unmanned aerial vehicle (UAV) to a rail configured to be electrified at ground-level;
coupling a charging contact on the UAV with a charging contact coupled to the rail;
coordinating a charging operation between the UAV and the rail; and
instructing the UAV to disengage the charging contact on completion of the charging operation.

9. The method of claim 8, comprising instructing the UAV to land on a mobile platform coupled to the rail.

10. The method of claim 9, comprising:
receiving a beacon signal from the mobile platform; and
aligning the UAV with the mobile platform based on the beacon signal.

11. The method of claim 8, comprising engaging a presence detection circuit to enable the rail.

12. The method of claim 8, comprising converting a direct current at a first voltage to a second voltage.

13. The method of claim 8, comprising broadcasting a location of the UAV.

14. The method of claim 8, comprising extending the charging contact from the UAV.

15. A system, comprising:
a mobile platform to operate on and receive power from a rail, the rail configured to be electrified at ground-level;
a first charging contact coupled to the mobile platform; and
a control circuit to:
enable a navigation aid to assist an unmanned aerial vehicle (UAV) in navigating to the mobile platform; and
coordinate a charging operation between the UAV and the rail via the first charging contact coupled to a second charging contact on the UAV.

16. The system of claim 15, wherein the control circuit is to instruct the UAV to disengage with the first charging contact.

17. The system of claim 15, wherein the control circuit is to broadcast a beacon signal for use by the UAV in aligning with the mobile platform.

18. The system of claim 15, wherein the control circuit is to engage a presence detection circuit of the rail to enable the rail.

19. The system of claim 15, wherein the control circuit is to convert a direct current at a first voltage to a second voltage.

20. The system of claim 15, wherein the control circuit is to broadcast a location of the mobile platform.
